(19) United States
(12) Patent Application Publication
(10) Pub. No.: US 2009/0142052 A1
(43) Pub. Date: Jun. 4, 2009

(54) Monitoring of Optical Signals

(76) Inventors: Steven Pegg, Surrey (GB); Marc Francis Charles Stephens, Warwickshire (GB); Robert Richard Packham, Hampshire (GB); Andrew Straw, Warwickshire (GB)

Correspondence Address: COATS & BENNETT, PLLC, 1400 Crescent Green, Suite 300, Cary, NC, 27518, US

(21) Appl. No.: 11/719,190

(22) PCT Filed: Nov. 10, 2005
(86) PCT No.: PCT/EP05/55886

§ 371 Date: Dec. 13, 2007

(30) Foreign Application Priority Data
Nov. 17, 2004 (GB) 0425271.4
Nov. 10, 2005 (EP) PCT/EP05/55886

(51) Int. Cl. H04B 10/08; H04J 14/02

(52) U.S. Cl. 398/26; 398/38; 398/79; 398/34

(57) ABSTRACT

An apparatus and method for monitoring of optical signals 60 at a node (12, 14, 16) in a WDM telecommunications system 10 comprising the employment of photodiodes (54, 56, 58). Each of the photodiodes (54, 56, 58) has a short response time relative to a number of bit periods of the optical signal to permit measurement of the optical power thereof. Such a photodiode (54, 56, 58) can be used to monitor many nodes (12, 14, 16) within the system 10 and facilitates monitoring of optical signals in nodes which are far apart. The photodiode (54, 56, 58) also permits the Optical Signal to Noise Ratio (OSNR) of the optical signal 60 to be calculated by obtaining values for a maximum optical power P₁ and a minimum optical power P₀ for a particular optical signal 60.

The present invention relates to the monitoring of optical signals in a WDM optical telecommunications network.

A known WDM optical telecommunications network includes a transmitting node and a receiving node for transmitting and receiving optical signals there between. In the case of a Dense Wavelength Division Multiplexing (DWDM) telecommunications network the transmitting node includes a plurality of lasers for generating a plurality of signals, each signal corresponding to a particular channel to be transmitted to the receiving node. In the transmitting node each of the signals are input to a multiplexer to produce one broadband signal which is input to a single optical fibre. The broadband signal may then be input to an Erbium Doped Optical Amplifier (EDFA) in the transmitting node for transmission to the receiving node that may be located thousands of kilometres away.

A small percentage of the optical power of the broadband signal emitted from the EDFA may be input to a Power Monitoring Unit (PMU) of the transmitting node. The PMU measures the averaged power of each of the plurality of signals in the broadband signal. To measure the Optical Signal to Noise Ratio (OSNR), the averaged power of one signal can be measured, and compared with the averaged power of the noise immediately adjacent to that signal in the frequency spectrum. A measure for the OSNR can then be calculated.

The OSNR for each of the plurality of signals can be used to provide an indication of the state of deterioration of the optical fibre over which the optical signal is transmitted. The PMU is typically a rack-mounted card and may cost up to £10,000 due to the expensive opto-electronic components used.

If the distance between the transmitting and receiving nodes is further than, say, 80 km apart an intermediate node may be required between them to maintain the power of the broadband signal. The intermediate node and the receiving node each have an EDFA to amplify the broadband signal and may be equipped with a PMU to determine the power and to calculate the OSNR of each of the plurality of signals. If the transmitting node and the receiving node are thousands of kilometres apart several tens of intermediate nodes may be required. Each EDFA in the respective nodes increases the power of each of the plurality of signals to overcome losses in the transmission fibre and optical components but also increases the overall noise level.

Several problems are associated with the prior way of monitoring the power of optical signals and the subsequent calculation of the OSNR. Such a calculation relies on the assumption that the noise level within a particular signal is the same as the noise levels at an optical frequency immediately adjacent that signal. This assumption is an approximation and may not necessarily be the case and this may result in an inaccurate calculation for the OSNR. Furthermore using the PMUs of each intermediate node is a very expensive way to determine the power of each of the plurality of signals. This is particularly the case when many intermediate nodes are required such as when the receiving node is 3000 km from the transmitting node.

Examples of prior known ways of monitoring the power of optical signals and the subsequent calculation of the OSNR that suffer from are above mentioned deficiencies are set out below.

In particular, EP 1376899 (Alcatel) relies on the assumption that the optical signal is limited to a narrow electrical bandwidth, while the noise is present over a much wider range. Hence electrical filtering allows both components to be measured independently to interpret the OSNR. This is not very accurate because the unfiltered noise value that is actually measured is spectrally removed from the signal frequency. Hence one cannot get a true “same wavelength” OSNR. This method of this citation differs from the present invention in that the present invention offers a direct measurement of OSNR at the wavelength (frequency) of interest. Furthermore, there is no disclosure as to how an OSNR is measured, or calculated, at the specific frequency of interest,. There is no mention of using maximum or minimum optical power levels of a single channel to calculate or obtain a measure of OSNR of that specific channel.

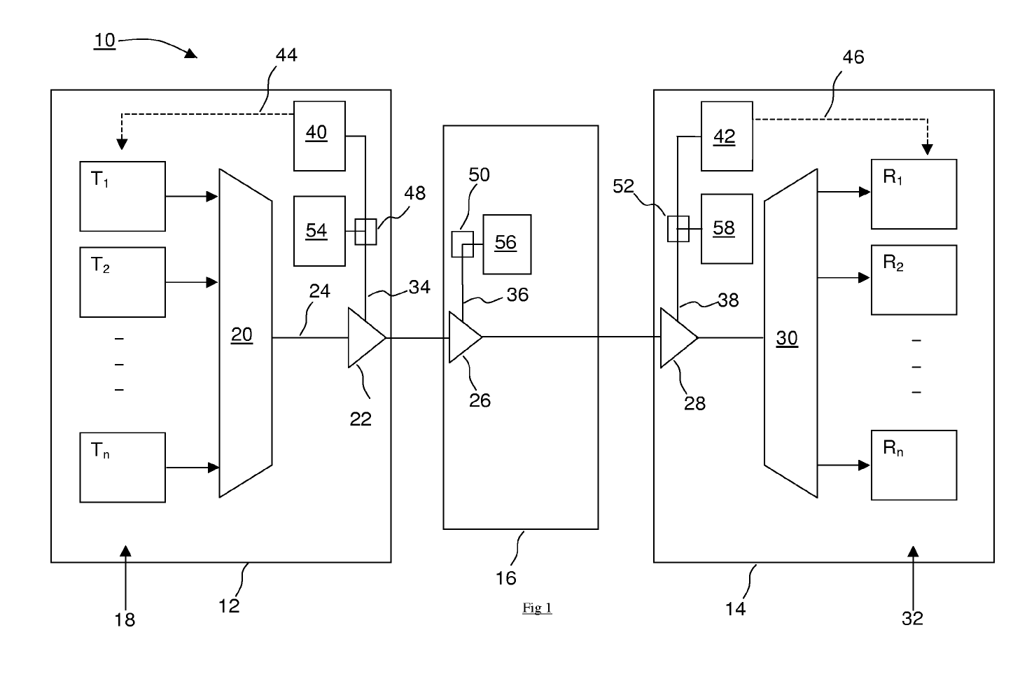

EP 0762677 (Fujitsu) is an example of the known way of getting an indicative OSNR measurement using a demultiplexing grating feeding a photodiode array. The method described compares an optical signal of a channel to a noise component near to that channel. (see page 7 lines 31 to 33 in relation to FIG. 1), Consequently this method suffers from the same inaccuracies as outlined above.

U.S. Pat. No. 6,396,051 (Sycamore) also relates to a conventional way of measuring OSNR by measuring the power of a channel and the power of noise of an adjacent channel to that of interest, (see column 7, equation 2, and lines 27 to 28) The apparatus of this cited patent also requires a tuneable filter to separate measurement of the power of a channel from the noise as discussed at column 9, lines 36 to 42.

US 2003/161163 (Lambda Crossing Ltd.) also relates to a conventional way of measuring OSNR but involves an extremely complicated and costly arrangement of splitters and tuneable filters to allow measurement of a number of optical parameters, as discussed on page 6, paragraph 71 and as shown in equation 1. In equation 1, S₁ is the optical signal to which a specific filter is tuned, whereas Sj are the rest of the optical signals in the channel of interest. This indicates that the power of the noise within a particular channel is not measured and only that of adjacent channels are measured.

All of the above-mentioned prior known methods are very costly, inaccurate ways of measuring OSNR.

An object of the present invention is to provide a method and apparatus for measuring optical signal to noise ratios of an optical signal that has improved accuracy and w is less expensive to implement than other known methods and apparatus

According to a first aspect of the invention there is provided an apparatus as set out in the attached claims that employs a photodiode having the characteristics set out in the claims.

According to a second aspect of the invention there is provided method as set out in the attached claims that employs a photodiode having the characteristics set out in the claims.

According to a second aspect of the invention there is provided WDM telecommunications system as set out in the attached claims that employs an apparatus as claimed in the attached claims.

The apparatus and method of the present invention provides a ready way of monitoring an optical signal of a W)M telecommunications system that can be used to measure OSNR at a transmitting node, an intermediate node, or a receiving node of the system. The photodiodes cost in the region of a few tens of pounds and are relatively inexpensive when compared to the Power Monitoring Unit (PMU) of the prior telecommunications network that can cost £10,000 or more.

In accordance with the present invention the Optical Signal to Noise Ratio (OSNR) is calculated by obtaining values for a maximum optical power (P₁) and a minimum optical power (P₀) of the optical signal in a selected channel at the same optical frequency. The maximum optical power (P₁) represents the sum of the signal optical power (P1) and the noise optical power (P₀), whereas the minimum optical power (P₀) represents the noise optical power only. The OSNR can then be calculated to determine the quality of the optical signal. This enables one to use an improved way of calculating the OSNR when compared to the prior known methods. This is because the measured values for maximum and minimum optical power (P₁ and P₀) contain the optical noise power at the same optical frequency as that of the optical signal, which is in contrast to the prior way of calculating the OSNR.

The response time of the photodiode is preferably shorter than twenty-two bit periods and this permits sampling of an optical signal that includes twenty-two logical ones in a row. Typically, if there are more than twenty-two logical ones in a row the optical signal is scrambled by the WDM system. The response time of the, or each, photodiode represents an interval of time which permits the photodiode to measure the power of the optical signal. Ideally the photodiode should have a response time of the order of less than half the bit period of the optical signal. However, such photodiodes would be much more expensive than would be those that have response times in the preferred practical range of between one half of a bit period of the optical signal and twenty two bit periods of the optical signal.

In the preferred embodiment of the invention, the, or each photodiode has a response time of between one half a bit period of the optical signal and five bit periods of the optical signal. Such preferred response times permit effective sampling of an optical signal having a return to zero (RZ) data format.

In a preferred embodiment of the invention, an optical amplifier having an optical output is provided at one or more of the nodes and the photodiodes are provided at the optical output of the amplifier.

An optical filter may be provided to enable one to select a particular optical signal using the optical filter. Such a filter permits measurement of the power of a chosen signal (60) of a WDM system that has a plurality of optical signals. This optical filter is a particularly useful feature for a DWDM system. The preferred form of filter is a thin film filter.

The present invention enables monitoring the optical signal from the plurality of nodes via a single channel of the WDM system. This represents an inexpensive way of monitoring the WDM system. This is particularly the case when there are many intermediate nodes within the WDM system for amplifying signals and when a transmitting node and a receiving node are far apart.

According to a second aspect of the invention there is provided a WDM telecommunications system including a node having a photodiode, the photodiode having a response time which is shorter than twenty two bit periods of an optical signal of the node, wherein the photodiode has measurement means to measure the maximum and minimum optical power of an optical signal of the node, and calculation means are provided to calculate the optical signal to noise ratio.

The present invention will now be described, by way of example only, with reference to the accompanying drawings, in which:

FIG. 1 is a schematic diagram of a WDM telecommunications system incorporating optical signal monitoring according to the present invention.

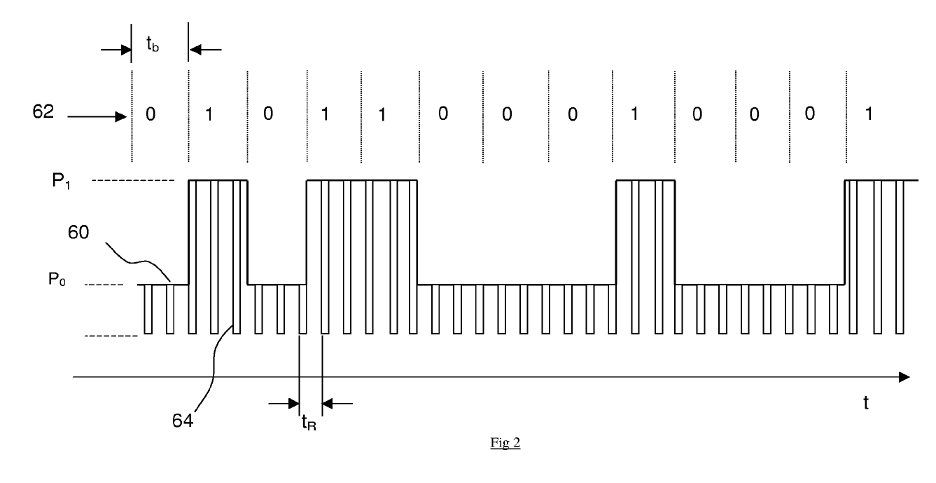

FIG. 2 is a diagram illustrating the measurement of an optical signal of one channel in the telecommunications network of FIG. 1.

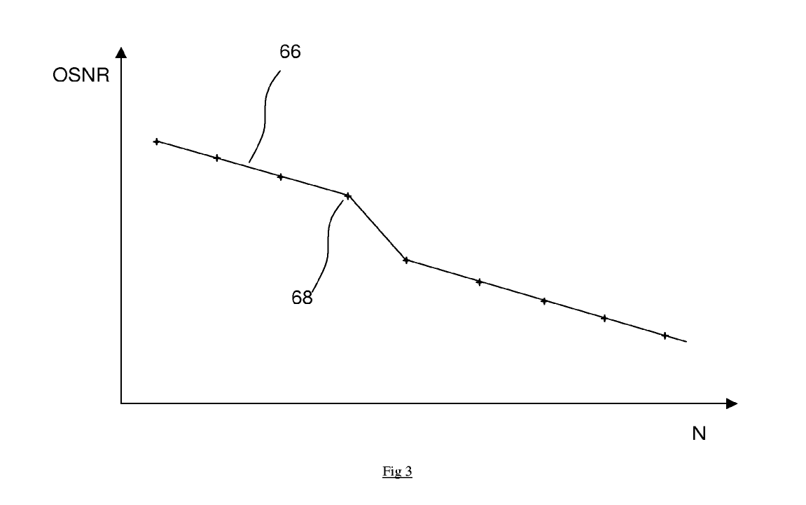

FIG. 3 is a graphical representation the OSNR for a particular signal measured at a series of nine intermediate nodes.

Referring to FIG. 1, there is shown a schematic diagram of a WDM telecommunications system, generally designated 10, incorporating an apparatus (9) for monitoring the power of an optical signal (60) in a selected transmission channel of the network. The telecommunications system 10 may operate using Dense WDM (DWDM) or Coarse WDM (CWDM) or any other technique for transmitting multiple wavelengths (λ) simultaneously over a single fibre such as Optical Core Division Multiplexing (OCDM). By DWDM transmission with for example 200 GHZ, 100 GHz, 50 GHz or 25 GHz wavelength spacing, and by CWDM transmission with for example 2500 GHz wavelength spacing is meant.

The optical telecommunications system 10 includes a transmitting node 12, a receiving node 14, and an intermediate node 16. The receiving node 14 is located at a distance of 160 km from the transmitting node 12 with the intermediate node 16 located approximately half way therebetween. The transmitting node 12 includes a series of lasers 18 labelled as T₁ -Tₙ for transmitting optical signals, a multiplexer 20 and an Erbium Doped Fibre Amplifier (EDFA) 22. The number of lasers (n) corresponds to the number of channels to be transmitted to the receiving node 14. The signals from the lasers 18 are input to the multiplexer 20 that outputs a broadband signal via a single optic fibre 24 to the EDFA 22. The EDFA 22 of the transmitting node 12 outputs to the intermediate node 16. The intermediate node 16 includes a respective EDFA 26 for amplifying the broadband signal from the transmitting node 12. In turn, the intermediate node 16 outputs to the receiving node 14. The receiving node 14 includes a respective EDFA 28, a demultiplexer 30 and a series of receiving units 32 labelled as R₁-Rₙ. The number of receiving units (n) corresponds to the number of channels (n) to be received from the transmitting node 12 (provided no asymmetric add/drop has occurred in middle of the link). The EDFA 28 of the receiving unit 14 amplifies the broadband signal from the intermediate node 16 and outputs to the demultiplexer 30. In turn, the demultiplexer 30 outputs to the receiving units 32.

Each of the EDFAs 22, 26, 28 have a known optical tap 34, 36, 38 which typically outputs about 1 to 5% of the optical power from the associated EDFA 22, 26, 28 for power measurement purposes. The optical taps 34, 38 of the EDFAs 22, 28, output to respective Power Monitoring Units (PMU) 40, 42 that are of known kind. The PMUs 40, 42 measure the averaged power for each of the (n) different channels, and provides a feedback for controlling the power of the lasers 18, and for controlling the characteristics of the receivers 32 as required via respective control lines 44, 46. Each of the optical taps 34, 36, 38 of the EDFAs 22, 26, 28 are provided with respective Thin Film Filters (TFF) 48, 50, 52 that divert part of the optical power of a selected channel to a respective photodiode 54, 56, 58 for optical power measurement according to the present invention. It will be appreciated that whilst TFFs 48, 50, 52 are shown, other tuneable filters or grating based demultiplexers could be used to perform the same function as the TFFs 48, 50 52. Each of the TFFs 48, 50, 52 is fixed to a particular channel as required for monitoring the optical signal of that channel. The skilled person will know the requirements for specifying such a TFF 48, 50, 52 for a particular channel.

FIG. 2 is a diagram illustrating the measurement of an optical signal 60 of one channel in the telecommunications network of FIG. 1. The optical signal 60 has a Non-Return to Zero (NRZ) data format. The optical signal 60 represents a channel that has been selected by a particular TFF 48, 50, 52 so that optical signal monitoring can be performed by a particular photodiode 54, 56, 58. The photodiodes 54, 56, 58 have a predefined response, so that an incident optical power produces a given photocurrent. Therefore, measurement of the photocurrent provides a measure for the incident optical power. The photocurrent can be measured using an ammeter that constitutes a measurement means for measuring the optical power. The optical signal 60 is a typical signal transmitted by one of the lasers 18 of the system 10, and comprises a series of bits generally labelled 62. Each bit 62 has a bit period t_{b} that has a duration of 0.1 ns for a 10 Gb/s optical signal. Power measurement of the optical signal 60 by each of the photodiodes 54, 56, 58 is represented by the line 64 in FIG. 2 which represents the response time T_{R} of the photodiode 54, 56, 58. The response time t_{R} is a property of the photodiode and is dependent (among other things) on the carrier lifetime of the material of the photodiode. In FIG. 2 t_{R} is shown to be approximately 3 times shorter than the bit period t_{b} of the optical signal 60. A suitable length of time for t_{R} would be about 10-30 ps for a 10 Gb/s optical signal.

In FIG. 2, it can be seen that the optical signal 60 includes two logical ones in a row and three logical zeros in a row. Therefore, if the response time of the photodiode 48, 56, 58 is slightly longer than the bit period, then measurement of the maximum power (P₁) and minimum power (P₀) of the optical signal can still be achieved, albeit less frequently. The limit of the response time of the photodiode 48, 56, 58 to be able to sample an optical signal, is a function of the statistical probability that the optical signal 60 will have many logical ones and zeros in a row. One caveat to this limit is that when more than twenty-two logical ones occur in a row, the WDM system scrambles the signal. It will be appreciated that twenty-two logical ones in a row occurs relatively infrequently and measuring the maximum and minimum power (P₁ and P₀) of the optical signal (60) would only be infrequently achieved. A reasonable compromise of the length of time for power measurement is a maximum response time of less than five bit periods of the optical signal 60.

Whilst FIG. 2 shows an optical signal 60 having an NRZ data format, it will be appreciated that the invention is adaptable to an optical signal having a Return to Zero (RZ) data format, with the proviso that t_{R} is correspondingly shorter. Such a response time would be less than half the bit period.

The photodiodes 54, 46, 48 measure the Optical Signal to Noise Ratio (OSNR) of the optical signal 60 by recording a high optical power (P₁) and a low optical power (P₀ ) for the signal 60. The high optical power (P₁) represents the combined optical signal power and the optical noise power, whereas the low optical power (P₀) represents the power of the optical noise. The ratio (P₁-P₀)/P₀ is then calculated and this is a measure of the OSNR. The noise optical power is always present in a given channel because the lifetime of the decay of the noise in the EDFAs 22, 26, 28 is significantly longer than the bit period t_{b}. Typically the optical noise power decays within a few microseconds whereas the signal power decays within a few fractions of a nanosecond for a 10 Gb/s signal. If the TFFs 48, 50, 52 are selected to monitor a particular part of the band containing the channels where a signal is not present the photodiode 54, 56, 58 can be used to monitor the power of the noise within the band.

In the case of the receiving node 14 being located at a distance of several thousand kilometres from the transmitting node 12 there may be tens of intermediate nodes 16 each having an EDFA 26. In this scenario, the optical power for each channel can be measured at each intermediate node 16 to provide a way of monitoring the optical telecommunications system 10. FIG. 3 is a graphical representation of the OSNR for a particular signal measured at a series of nine intermediate nodes, shown at 66. The OSNR is measured along the y-axis and the node number N is measured along the x-axis. The OSNR measured by each photodiode may be transmitted to the receiving node 14 where it may be plotted as the graph 66. Such transmission can be performed via a dedicated channel of the WDM system. From the graph 66 it can be seen that there is a drop in the optical performance at the 4^{th} intermediate node 16 which may be caused by a fault with the 4^{th} or 5^{th} intermediate nodes 16 or a fault in the transmission line therebetween. Accordingly an engineer can be sent to rectify the problem.

In this manner, it can be seen that the photodiodes 54, 56, 58 provide a ready way of monitoring the telecommunications system 10, and for measuring the optical power and calculating the OSNR. Accordingly alarms can be raised if signal quality falls. The photodiodes are relatively inexpensive compared to PMUs 40, 42 and are accordingly much less expensive to implement. This is particularly the case when many intermediate nodes 16 are required when the transmitting node 12 and the receiving node 14 are far apart.

It will be appreciated that calculation of an OSNR in the optical domain according to the invention is distinct from determining an electrical signal to noise ratio of a receiver 32 that is known from the prior art.

1-16. (canceled)

17. An apparatus for monitoring the optical power of an optical signal at a node in a Wavelength Division Multiplexing (WDM) telecommunications network, the apparatus comprising:
a photodiode having a response time that is shorter than twenty two bit periods of an optical signal, the photodiode configured to measure a maximum optical power (P₁) and a minimum optical power (P₀) of the optical signal;
whereby an optical signal to noise ratio (OSNR) of an optical signal on a selected channel may be calculated based on the measured maximum and minimum optical powers.

18. The apparatus of claim 17 wherein the photodiode has a response time of between one half bit period of the optical signal and twenty two bit periods of the optical signal.

19. The apparatus of claim 17 wherein the photodiode has a response time of between one half bit period of the optical signal and five bit periods of the optical signal.

20. The apparatus of claim 17 wherein the photodiode has a response time of less than half the bit period of the optical signal.

21. The apparatus of claim 17 further comprising an optical amplifier having an optical output, and wherein the photodiode is disposed at the optical output.

22. The apparatus of claim 17 further comprising an optical filter configured to permit the photodiode to measure the power of a particular optical signal.

23. The apparatus of claim 22 wherein the optical filter comprises a thin film filter.

24. A Wavelength Division Multiplexing (WDM) optical communications network comprising:
one or more nodes configured to transmit and receive an optical signal, each node comprising a photodiode having a response time that is shorter than twenty two bit periods of the optical signal, the photodiode configured to measure a maximum optical power (P1) and a minimum optical power (P0) of the optical signal;
whereby an optical signal to noise ratio (OSNR) of an optical signal on a selected channel may be calculated based on the measured maximum and minimum optical powers.

25. A node for a Wavelength Division Multiplexing (WDM) optical communications network, the node comprising:
a photodiode having a response time that is shorter than twenty two bit periods of an optical signal, the photodiode configured to measure a maximum optical power (P1) and a minimum optical power (P0) of the optical signal;
whereby an optical signal to noise ratio (OSNR) of an optical signal on a selected channel may be calculated based on the measured maximum and minimum optical powers.

26. A method of monitoring an optical signal in a Wavelength Division Multiplexing (WDM) optical telecommunications system having a plurality of nodes, at least one of which comprises a device to measure an optical power of the optical signal, comprising:
providing a photodiode at a node in a WDM optical telecommunications system, the photodiode having a response time that is shorter than twenty two bit periods of the optical signal;
measuring a maximum optical power (P₁) of the optical signal on a selected channel using the photodiode;
measuring a minimum optical power (P₀) of the optical signal on the selected channel using the photodiode; and
calculating an optical signal to noise ratio (OSNR) of the selected channel using the measured values for the maximum optical power (P₁) and the minimum optical power (P₀).

27. The method of claim 26 wherein the photodiode has a response time of less than half the bit period of the optical signal.

28. The method of claim 26 further comprising providing an optical amplifier having an optical output at the node, and wherein the photodiode is provided at the optical output of the amplifier.

29. The method of claim 26 further comprising:
providing an optical filter at the node; and
selecting the optical signal using the optical filter.

30. The method of claim 29 wherein the optical filter comprises a thin film filter.

31. The method of claim 26 wherein the WDM telecommunications system comprises a plurality of nodes, each node configured to calculate the OSNR of the selected channel using values measured for the maximum optical power (P₁) and the minimum optical power (P₀) by a photodiode.

32. The method of claim 31 further comprising:
remotely measuring the OSNR of the optical signal at a first node; and
comparing the remotely measured OSNR with the OSNR calculated at the first node.

33. The method of claim 31 further comprising monitoring the optical signal from the plurality of nodes via a selected channel of the WDM telecommunications system.
